(19) United States
(12) Patent Application Publication
(10) Pub. No.: US 2025/0071718 A1
(43) Pub. Date: Feb. 27, 2025

(54) ANTENNA CONFIGURATION FOR POSITIONING

(71) Applicant: NOKIA TECHNOLOGIES OY, Espoo (FI)

(72) Inventors: Johannes Harrebek, Aalborg (DK); Benny Vejlgaard, Gistrup (DK); Oana-Elena Barbu, Aalborg (DK); Ryan Keating, Chicago, IL (US); Tao Tao, Shanghai (CN)

(21) Appl. No.: 18/719,209

(22) PCT Filed: Dec. 13, 2021
(86) PCT No.: PCT/CN2021/137628

§ 371 Date: Jun. 12, 2024

(51) Int. Cl. H04W 64/00; H01Q 21/29; H04W 74/0833

(52) U.S. Cl. CPC H04W 64/00; H01Q 21/29; H04W 74/0833

(57) ABSTRACT

Embodiments of the present disclosure relate to devices, methods, apparatuses and computer readable storage media of antenna configuration for positioning. The method comprises identifying, at a first device, at least one second device hearable by the first device based on a monitoring of respective reference signals from the at least one second device; determining respective transmit power on at least two antenna panels allocated for the at least one second device based on a measurement associated with the respective reference signals; and transmitting, to the at least one second device, a message associated with a positioning of the first device by using the at least two antenna panels with the respective transmit power. In this way, the chance of successful PRACH for positioning reception at all identified involved gNBs may be optimized for maximized positioning accuracy at low latency and low UE power consumption.

### FIELD

Embodiments of the present disclosure generally relate to the field of telecommunication and in particular to devices, methods, apparatuses and computer readable storage media of antenna configuration for positioning.

### BACKGROUND

The 3rd Generation Partnership Project (3GPP) describes New Radio (NR) positioning support and some solutions are specified for NR positioning in 3GPP release 16 such as Downlink Time Difference of Arrival (DL-TDOA), Uplink Time Difference of Arrival (UL-TDOA), Downlink Angle of Departure (DL-AoD), Uplink Angle of Arrival (UL-AoA), Enhanced Cell ID (E-CID), and Multi-cell Round Trip Time (Multi-RTT).

In 3GPP release 17, it is expected that NR positioning may be enhanced for improving positioning accuracy, latency and network and/or device efficiency.

### SUMMARY

In general, example embodiments of the present disclosure provide a solution of antenna configuration for positioning.

In a first aspect, there is a method. The method comprises identifying, at a first device, at least one second device hearable by the first device based on a monitoring of respective reference signals from the at least one second device; determining respective transmit power on at least two antenna panels allocated for the at least one second device based on a measurement associated with the respective reference signals; and transmitting, to the at least one second device, a message associated with a positioning of the first device by using the at least two antenna panels with the respective transmit power.

In a second aspect, there is provided a method. The method comprises receiving, at a second device and from a first device, a message associated with a positioning of the first device transmitted by using the at least two antenna panels of the first device with the respective transmit power; in accordance with a determination that a configuration for the positioning of the first device associated with the random access is received from a third device, performing a positioning measurement associated with the received message; and transmitting a result of the positioning measurement to the third device.

In a third aspect, there is provided a method. The method comprises transmitting, from a third device and to at least one second device, a configuration for a positioning of a first device associated with a random access; receiving, from the at least one second device, a result of a positioning measurement associated with a message associated with a positioning of the first device; and determining the position of the first device based on the result.

In a fourth aspect, there is provided a first device. The first device comprises at least one processor; and at least one memory including computer program code; the at least one memory and the computer program code are configured to, with the at least one processor, cause the first device at least to identify, at a first device, at least one second device hearable by the first device based on a monitoring of respective reference signals from the at least one second device; determine respective transmit power on at least two antenna panels allocated for the at least one second device based on a measurement associated with the respective reference signals; and transmit, to the at least one second device, a message associated with a positioning of the first device by using the at least two antenna panels with the respective transmit power.

In a fifth aspect, there is provided a second device. The second device comprises at least one processor; and at least one memory including computer program codes; the at least one memory and the computer program codes are configured to, with the at least one processor, cause the second device at least to receive, at a second device and from a first device, a message associated with a positioning of the first device transmitted by using the at least two antenna panels of the first device with the respective transmit power; in accordance with a determination that a configuration for the positioning of the first device associated with the random access is received from a third device, perform a positioning measurement associated with the received message; and transmit a result of the positioning measurement to the third device.

In a sixth aspect, there is provided a third device. The third device comprises at least one processor; and at least one memory including computer program codes; the at least one memory and the computer program codes are configured to, with the at least one processor, cause the third device at least to transmit, from a third device and to at least one second device, a configuration for a positioning of a first device associated with a random access; receive, from the at least one second device, a result of a positioning measurement associated with a message associated with a positioning of the first device; and determine the positioning of the first device based on the result.

In a seventh aspect, there is provided an apparatus comprising means for identifying, at a first device, at least one second device hearable by the first device based on a monitoring of respective reference signals from the at least one second device; means for determining respective transmit power on at least two antenna panels allocated for the at least one second device based on a measurement associated with the respective reference signals; and means for transmitting, to the at least one second device, a message associated with a positioning of the first device by using the at least two antenna panels with the respective transmit power.

In an eighth aspect, there is provided an apparatus comprising means for receiving, at a second device and from a first device, a message associated with a positioning of the first device transmitted by using the at least two antenna panels of the first device with the respective transmit power; means for in accordance with a determination that a configuration for the positioning of the first device associated with the random access is received from a third device, performing a positioning measurement associated with the received message; and means for transmitting a result of the positioning measurement to the third device.

In a ninth aspect, there is provided an apparatus comprising means for transmitting, from a third device and to at least one second device, a configuration for a positioning of a first device associated with a random access; means for receiving, from the at least one second device, a result of a positioning measurement associated with a message associated with a positioning of the first device; and means for determining the position of the first device based on the result.

In a tenth aspect, there is provided a computer readable medium having a computer program stored thereon which, when executed by at least one processor of a device, causes the device to carry out the method according to the first aspect, the second aspect, the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 shows a signaling chart illustrating a process of antenna configuration for positioning according to some example embodiments of the present disclosure;

FIG. 3 shows a flowchart of an example method of antenna configuration for positioning according to some example embodiments of the present disclosure;

FIG. 4 shows a flowchart of an example method of antenna configuration for positioning according to some example embodiments of the present disclosure;

FIG. 5 shows a flowchart of an example method of antenna configuration for positioning according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

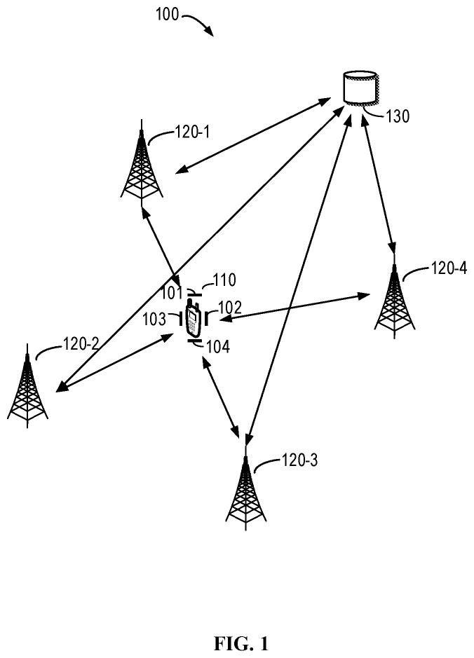

FIG. 1 shows an example communication network 100 in which embodiments of the present disclosure can be implemented. As shown in FIG. 1, the communication network 100 may comprise a terminal device 110 (hereinafter may also be referred to as a UE 110 or a first device 110). The terminal device 110 may be configured with a plurality of antenna arrays/panels. For example, the terminal device 110 may be configured with four antenna arrays, namely 101, 102, 103 and 104, which can be arranged at different locations on the terminal device 110. The terminal device 110 may keep track of the best antenna array to use for a link to a serving cell/gNB.

The communication network 100 may further comprise network device 120-1, 120-2, 120-3 and 120-4 (hereinafter may also be referred to as a gNB 120 or a second device 120 collectively), which may be configured to communicate with the terminal device 110. In some scenarios, the network device 120-1 may act as a serving gNB of the terminal device 110, while network device 120-2, 120-2 and 120-3 may act as neighbor gNBs.

The communication network 100 may also comprise a Location Management Function (LMF) 130 (hereinafter may also be referred to as a third device 130), which may be configured to communicate with the terminal device 110 and network device 120-1, 120-2, 120-3 and 120-4. The LMF 130 may be referred to as a positioning management function.

It is to be understood that the number of network devices and terminal devices and the number of antenna arrays/panels arranged at the terminal device 110 shown in FIG. 1 is given for the purpose of illustration without suggesting any limitations. The communication network 100 may include any suitable number of network devices, terminal devices and antenna arrays/panels.

Depending on the communication technologies, the network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, future communication protocols, like 6G for example. The techniques described herein may be used for the wireless networks and radio technologies mentioned above as well as other wireless networks and radio technologies. For clarity, certain aspects of the techniques are described below for LTE, and LTE terminology is used in much of the description below.

New Radio (NR) has introduced a new RRC state called “RRC inactive (RRC_INACTIVE)” to meet the requirement of 5G services. The inactive state intends to limit battery consumption for the UE similarly to the idle state, while at the same time the UE may reach the connected state with little signaling when to send data. In inactive state, the UE remains Evolved Packet System Connection Management (ECM)-connected from 5GC (5G core network) point of view and therefore the Next Generation (NG) connection between 5GC and cell is maintained.

It has been discussed that methods, measurements, signaling and procedures are to be specified to support positioning for UEs in RRC_INACTIVE state, for UE-based and UE-assisted positioning solutions. For example, downlink (DL) NR positioning methods and Radio access technology (RAT) independent positioning methods propose that UE positioning measurements can be supported for UEs in RRC_INACTIVE state and positioning measurement or location estimate performed in RRC_INACTIVE can be reported when the UE is in RRC_INACTIVE state. Furthermore, it is specified that gNB positioning measurements is supported for UEs in RRC_INACTIVE state.

Moreover, the use of Physical Random Access Channel (PRACH) for positioning has been discussed for DL and uplink (UL) positioning in idle/inactive modes. In the PRACH positioning, the LMF may inform the serving gNB that UE idle/inactive mode positioning is requested and provide PRACH for positioning configuration and other assistance data to involved gNBs, which may comprise the serving gNB and other neighbour gNBs. After receiving the paging information for idle/inactive mode positioning, the UE may transmit PRACH for positioning for the involved gNBs to measure PRACH and report results to the LMF. Then the LMF may perform the UE position estimation.

In general, each UE antenna may perform beam steering but only within a portion of the full radiation sphere can be covered. To cover full radiation sphere, it is expected that the UE may have multiple antenna panels to perform beam steering. A Multi-Panel UE (MPUE) may exhibit different implementations regarding its capabilities for simultaneous transmission/reception. For example, for MPUE-Assumption1, multiple panels are implemented on a UE and only one panel can be activated at a time, with panel switching/activation delay of few ms. It may also be possible that multiple panels are implemented on a UE and multiple panels may be activated at a time and one or more panels can be used for Transmit (Tx) for the MPUE-Assumption2, or multiple panels are implemented on a UE and multiple panels can be activated at a time but only one panel can be used for Tx MPUE-Assumption3. The MPUE-Assumption2 is considered for the proposed low latency low power inactive/idle mode positioning procedure which is at least capable of transmitting the same TX signal on multiple panels simultaneously with total power obeying the UE power class maximum.

In general, a Frequency Range 2 (FR2) mmWave UE is equipped with more than one antenna array to approximate omnidirectional coverage. During normal UE inactive/idle mode paging the UE will keep track of the antenna array to use for the serving cell link. The best antenna array to use may be the one receiving for example with a highest Reference Signal Receive Power (RSRP) value or Line of Sight (LOS) RSRP. The gNB is paging the UE with a TX beam configured in direction of the UE. This may be with sector wide broad or narrower beam width dependent on the UE location knowledge available.

The UE may receive the paging message from the serving gNB using the identified best antenna array (for example, the antenna array 101) out of the four arrays available and with wide or narrow RX beam width dependent on how accurate the UE can estimate the direction of the serving gNB. When the paging is for PRACH UL transmission, the UE will again use the serving link selected antenna array and will use the same TX beam configuration as used for DL paging reception due to channel reciprocity.

The UE is not transmitting the PRACH in an omnidirectional manner and thus the PRACH may not reach all the expected and required number of neighbour gNBs or the gNBs actually capable of measuring the PRACH may be clustered in a limited area covered by the used UE serving gNB UL beam which may significantly impact the positioning accuracy, worst case preventing triangulation.

Therefore, by the present disclosure, it is expected that the chance of successful PRACH for positioning reception at all identified involved gNBs may be optimize for maximized positioning accuracy at low latency and low UE power consumption.

The present disclosure proposes a solution of UE antenna configuration for positioning. In this solution, the UE identifies at least one gNB hearable by the UE based on a monitoring of respective reference signals from the at least one gNB. The UE may determine respective transmit power on at least two antenna panels allocated for the at least one gNB based on a measurement associated with the respective reference signal. The UE transmits, to the at least one gNB, a message associated with a positioning of the UE by using the at least two antenna panels with the respective transmit power.

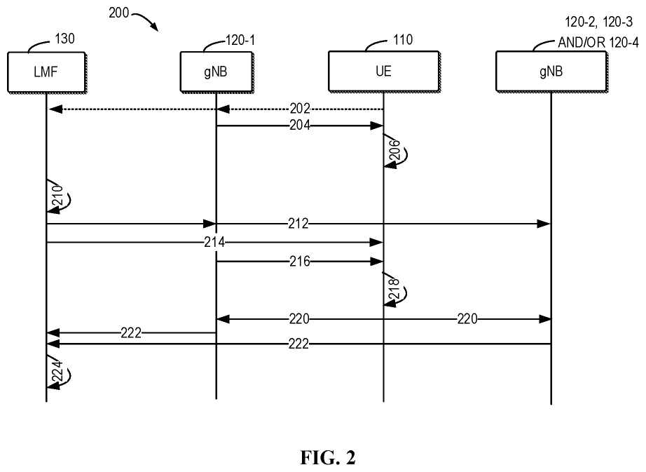

Principle and implementations of the present disclosure will be described in detail below with reference to FIG. 2, which shows a signaling chart illustrating a process 200 of antenna configuration for positioning according to some example embodiments of the present disclosure. For the purpose of discussion, the process 200 will be described with reference to FIG. 1. The process 200 may involve the UE 110, the serving gNB 120-1, the neighbour gNBs 120-2, 120-3 and/or 120-4 and the LMF 130 as illustrated in FIG. 1.

In some example embodiments, as shown in FIG. 2, the UE 110 may report 202 its capability of performing a multi-panel UL transmission for positioning to the serving gNB 120-1, for example, in a Radio Resource Control (RRC) connected state and the serving gNB 120-1 may forward this capability of UE 110 to the LMF 130. If the LMF 130 is aware of the capability of a multi-panel UL transmission for positioning of the UE 110, the LMF 130 may request this positioning approach for this capable UE 110.

The serving gNB 120-1 may indicate 204 the UE 110 to enter the RRC idle/inactive mode. After entering the RRC idle/inactive mode, the UE 110 may wake up for normal paging from the serving gNB 120-1 based on a preconfigured period and perform 206 the reference signal monitoring such as Synchronization Signal and Physical Broadcast Channel, SS/PBCH, blocks (SSB) monitoring for hearable gNBs 120-1, 120-2, 120-3 and/or 120-4 on some or all antenna panels arranged at the UE 110.

In some example embodiments, based on the SSB monitoring, the UE 110 may log the record associated with the monitoring result. For example, the UE 110 may log the cell identifications (IDs) and the Reference Signal Received Power (RSRP) of the reference signal (for example SSB) with timestamps. There will be multiple SSBs from a single neighbor cell. The UE may log the “Best” SSB RSRP, which means that it has a highest RSRP value or Line of Sight (LOS) RSRP.

Furthermore, the UE 110 may log the indices of the antenna panels used for the RSRP measurement or other related measurements during the monitoring.

In some example embodiments, during the monitoring on SSB, the UE may also track the LoS status or other positioning quality metric to hearable neighbor gNBs. For example, the positioning quality metric may also be referred to as a combination of estimated LoS status and RSRP, for example, a weighted sum after the values have been normalized.

In some example embodiments, it is to be understood that the UE 110 may have or may not have a capability for receiving and decoding the SSBs on all or some panels in parallel.

The LMF 130 may configure 210 a superset of gNBs 120 for PRACH for the positioning measurements. For example, the LMF 130 may determine the range of the superset of gNBs 120 based on how accurately the UE 110 approximate location is known at the LMF 130. Then the LMF 130 may inform 212 the involved gNBs 120 which belong to the superset of, for example, the serving gNB 120-1 and the neighbor gNBs 120-2, 120-3 and/or 120-4, as shown in FIG. 2, that the corresponding positioning measurement associated with the UE 110 is required.

The LMF 130 may request 214 the UE 110 to perform positioning PRACH transmission via dedicated paging for positioning which does not carry information on involved gNBs and associated PRACH power or spatial relation. Then the serving gNB 120 may transmit 216 the paging for positioning to the UE 110.

In some example embodiments, this request may be aligned with the SSB transmissions to increase the chance that the SSB log is up to date within the channel coherence time when initiating the positioning PRACH transmissions.

After received the paging for positioning, the UE 110 may identify the hearable gNBs 120 based on the monitoring of the reference signal (for example, the SSB), which can be performed previously as described above. The UE 110 may also group the identified hearable gNBs 120 on at least two antenna panels and determine 218 the respective Tx power on the at least two antenna panels. The UE 110 may group the identified hearable gNBs 120 and determine the respective Tx power based on measured SSB RSRP accommodating the need of the gNB farthest away within the total max UL power limitation.

When the UE determines the at least two antenna panels for transmitting the positioning PRACH, the UE 110 may also consider the obtained LOS status or the measured RSRP. In some example embodiments, the UE 110 may turn off some panels. For example UE 110 may turn off some panels in a case where the UE 110 fails to receive any SSBs above a threshold and/or based on only NLoS status on those panels. For example, if the UE 110 has four panels but only three of them receive a LoS signal from the neighboring cells, then the UE 110 may only transmit on the three panels instead of four panels.

In some example embodiments, positioning service requirement of the UE 110, such as Quality of Service (QoS) may also be considered when the UE 110 determines the respective Tx power on the at least two antenna panels. For example, if the UE 110 knows the positioning service requirement is not high (e.g., less positioning accuracy), the PRACH may not need to be hearable by too many gNBs. Hence, the UE may allocate relative less Tx power for PRACH for power saving.

In some example embodiments, the UE 110 may consider a time passed between latest SSB reception and the configuration of positioning PRACH when the UE 110 determines the Tx power. For example, if the time passed is larger than, for example the channel coherence time, the UE 110 may determine that the UL/DL channel reciprocity may be lost. In this case, the UE may revert to transmitting on all antenna arrays with substantially same power.

In some example embodiments, if the UE 110 determines that there is not a sufficient number of gNBs reachable at available UL power for the RX beam configurations used, the UE may increase respective antenna gains on a portion of the at least two antenna panels corresponding to one or more specific gNBs. For example, the UE 110 may select a gNB identified at a panel for which the target UL power can be met by an increase in antenna gain which is either feasible to obtain by a fast narrower receive beam alignment on available DL reference signal or chose a narrow beam configuration towards the selected gNB already available from other mobility measurements.

After determining the Tx power on the at least two antenna panels, the UE 110 may transmit 220 a message of the positioning PRACH to the hearable gNBs by using the at least two antenna panels with determined Tx power. In some example embodiments, the UE 110 may transmit the positioning PRACH with determined Tx power simultaneously on all identified antenna panels.

After received the positioning PRACH from the UE 110, the gNBs which belongs to the superset configured by the LMF 130, may perform the corresponding positioning measurement and report 222 the measurement result to the LMF 130.

The LMF 130 then may perform 224 estimation for the positioning of the UE 110. In some example embodiments, if adequate measurement results at adequate quality are received, the LMF 130 may estimate the UE position. Otherwise, if the inadequate number of quality measurements is received, the LMF 130 may adjust the positioning PRACH configuration for the positioning of the UE 110 by using the obtained measurement results. For example, the LMF 130 may enhance the coarse UE location and refine the superset gNB list for an idle/inactive mode positioning retry. Alternatively, the LMF 130 may also request the UE to wake up and perform RRC connected UE positioning.

With the solution of the present disclosure, the UE may transmit simultaneously the positioning PRACH on all relevant antenna arrays and not just on the serving cell antenna array. In this way, the chance of successful PRACH for positioning reception at all identified involved gNBs may be optimize for maximized positioning accuracy at low latency and low UE power consumption.

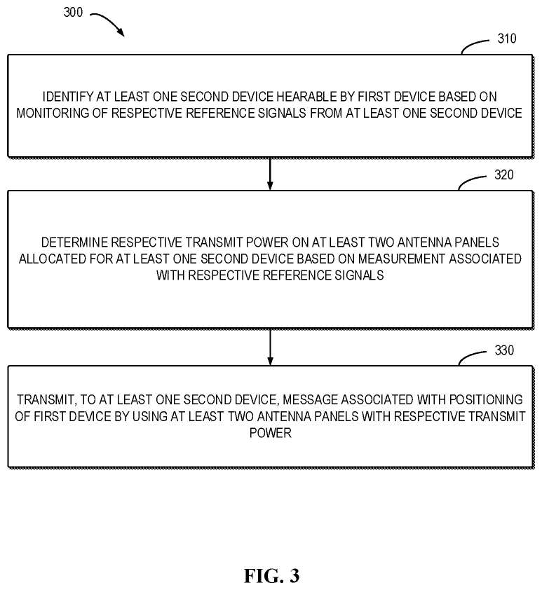

FIG. 3 shows a flowchart of an example method 300 of antenna configuration for positioning according to some example embodiments of the present disclosure. The method 300 can be implemented at the first device 110 as shown in FIG. 1. For the purpose of discussion, the method 300 will be described with reference to FIG. 1.

At 310, the first device identifies at least one second device hearable by the first device based on a monitoring of respective reference signals from the at least one second device.

At 320, the first device determines respective transmit power on at least two antenna panels allocated for the at least one second device based on a measurement associated with the respective reference signals.

At 330, the first device transmits, to the at least one second device, a message associated with a positioning of the first device by using the at least two antenna panels with the respective transmit power.

In some example embodiments, the first device may record a monitoring log related to the monitoring of the respective reference signals, the monitoring log comprising at least one of respective indices of one or more cells associated with the at least one second device, a received power level with a received time stamp for each of the respective reference signals, respective line of sight status associated with the at least one second device, or respective indices of antenna panels used for the monitoring.

In some example embodiments, the first device may group the at least one second device into one or more second device groups based on the recorded monitoring log; and determine a transmit power for respective one antenna panel allocated for each of one or more second device groups.

In some example embodiments, the first device may obtain information associated with positioning service requirement of the first device; and determine the transmit power for respective one antenna panel based on the information associated with the positioning service requirement.

In some example embodiments, if the first device determines that a difference between a time point when the positioning is requested and a further time point when a target reference signal of the respective reference signals is received exceeds a threshold difference, the first device may set the respective transmit power on the at least two antenna panels to be substantially same without exceeding a transmit power threshold.

In some example embodiments, if the first device determines that the number of second devices reachable by using an available transmit power is insufficient, the first device may increase respective antenna gains on a portion of the at least two antenna panels corresponding to one or more target second device.

In some example embodiments, the first device may determine the at least two antenna panels based on at least one of respective line of sight status associated with the at least one second device or received power levels of the respective reference signals.

In some example embodiments, the respective reference signals comprise one or more SSBs.

In some example embodiments, the first device may report a capability for performing an uplink transmission for the positioning of the first device on multiple panels.

In some example embodiments, the message comprises a physical random access channel message.

In some example embodiments, the at least two antenna panels comprises at least one antenna panel allocated for the at least one second device excluding a second device associated with a serving cell of the first device.

In some example embodiments, the first device comprises a terminal device and the second device comprises a network device.

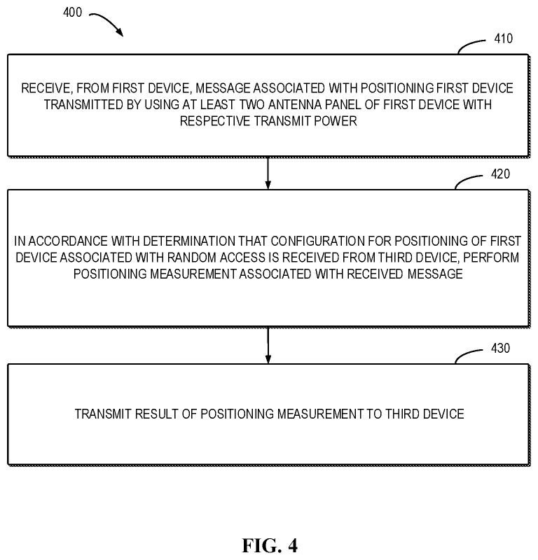

FIG. 4 shows a flowchart of an example method 400 of antenna configuration for positioning according to some example embodiments of the present disclosure. The method 400 can be implemented at the second device 120-1 as shown in FIG. 1. For the purpose of discussion, the method 400 will be described with reference to FIG. 1.

At 410, the second device receives, from a first device, a message associated with a positioning of the first device transmitted by using the at least two antenna panels of the first device with the respective transmit power.

At 420, if the second device determines that a configuration for the positioning of the first device associated with the random access is received from a third device, the second device performs a positioning measurement associated with the received message.

At 430, the second device may transmit a result of the positioning measurement to the third device.

In some example embodiments, the second device may receive, from a first device, a capability for performing an uplink transmission for the positioning of the first device on multiple panels.

In some example embodiments, the message comprises a physical random access channel message.

In some example embodiments, the first device comprises a terminal device and the second device comprises a network device, and the third device comprises a network management function associated with the positioning.

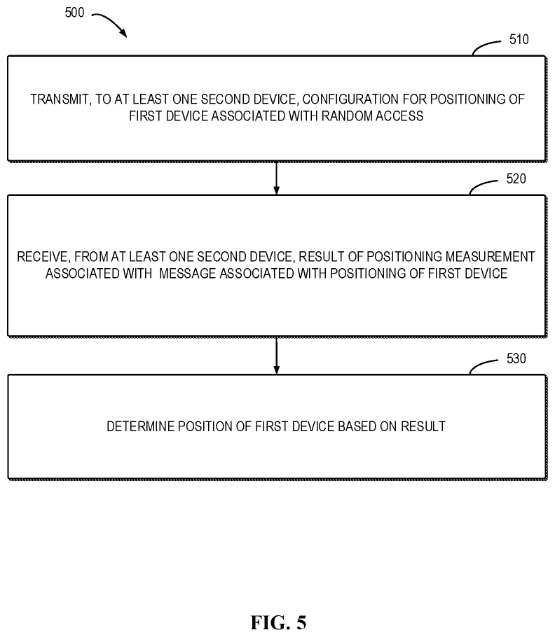

FIG. 5 shows a flowchart of an example method 500 of antenna configuration for positioning according to some example embodiments of the present disclosure. The method 500 can be implemented at the third device 130 as shown in FIG. 1. For the purpose of discussion, the method 500 will be described with reference to FIG. 1.

At 510, the third device transmits, to at least one second device, a configuration for a positioning of a first device associated with a random access.

At 520, the third device receives, from the at least one second device, a result of a positioning measurement associated with a message associated with a positioning of the first device.

At 530, the third device determines the positioning of the first device based on the result.

In some example embodiments, the third device may obtain, from a first device, a capability for performing an uplink transmission for the positioning of the first device on multiple panels.

In some example embodiments, the third device may determine the configuration for the positioning of the first device based on an accuracy requirement of the positioning.

In some example embodiments, if the third device determines that the determined positioning of the first device is unsatisfied, the third device may adjust the configuration for the positioning of the first device based on the result; or transmit an indication for waking up the first device to a radio resource control connected state.

In some example embodiments, the message comprises a physical random access channel message.

In some example embodiments, the first device comprises a terminal device and the second device comprises a network device, and the third device comprises a network management function associated with the positioning.

In some example embodiments, an apparatus capable of performing the method 300 (for example, implemented at the UE 110) may comprise means for performing the respective steps of the method 300. The means may be implemented in any suitable form. For example, the means may be implemented in a circuitry and/or software module.

In some example embodiments, the apparatus comprises means for identifying, at a first device, at least one second device hearable by the first device based on a monitoring of respective reference signals from the at least one second device; means for determining respective transmit power on at least two antenna panels allocated for the at least one second device based on a measurement associated with the respective reference signals; and means for transmitting, to the at least one second device, a message associated with a positioning of the first device by using the at least two antenna panels with the respective transmit power.

In some example embodiments, an apparatus capable of performing the method 400 (for example, implemented at the gNB 120) may comprise means for performing the respective steps of the method 400. The means may be implemented in any suitable form. For example, the means may be implemented in a circuitry and/or software module.

In some example embodiments, the apparatus comprises means for receiving, at a second device and from a first device, a message associated with a positioning of the first device transmitted by using the at least two antenna panels of the first device with the respective transmit power; means for in accordance with a determination that a configuration for the positioning of the first device associated with the random access is received from a third device, performing a positioning measurement associated with the received message; and means for transmitting a result of the positioning measurement to the third device.

In some example embodiments, an apparatus capable of performing the method 500 (for example, implemented at the LMF 130) may comprise means for performing the respective steps of the method 500. The means may be implemented in any suitable form. For example, the means may be implemented in a circuitry and/or software module.

In some example embodiments, the apparatus comprises means for transmitting, from a third device and to at least one second device, a configuration for a positioning of a first device associated with a random access; means for receiving, from the at least one second device, a result of a positioning measurement associated with a message associated with a positioning of the first device; and means for determining the position of the first device based on the result.

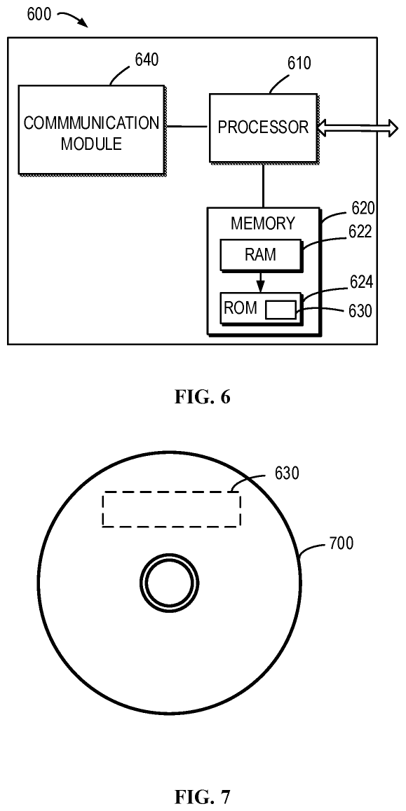

FIG. 6 is a simplified block diagram of a device 600 that is suitable for implementing embodiments of the present disclosure. The device 600 may be provided to implement the communication device, for example the UE 110, the gNB 120 and the LMF 130 as shown in FIG. 1. As shown, the device 600 includes one or more processors 610, one or more memories 640 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any process of the disclosure as discussed with reference to FIGS. 2 to 5. The embodiments of the present disclosure may also be implemented by hardware or by a combination of software and hardware.

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 300-500 as described above with reference to FIGS. 3-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus at least to:
identify, at the apparatus, at least one network device hearable by the apparatus based on a monitoring of respective reference signals from the at least one network device;
determine respective transmit power on at least two antenna panels allocated for the at least one network device based on a measurement associated with the respective reference signals; and
transmit, to the at least one network device, a message associated with a positioning of the apparatus by using the at least two antenna panels with the respective transmit power.

2. The apparatus of claim 1, wherein the apparatus is further caused to:
record a monitoring log related to the monitoring of the respective reference signals, the monitoring log comprising at least one of:
respective indices of one or more cells associated with the at least one network device;
a received power level with a received time stamp for each of the respective reference signals;
respective line of sight status associated with the at least one network device; or
respective indices of antenna panels used for the monitoring.

3. The apparatus of claim 2, wherein the apparatus caused to determine the respective transmit power comprises the apparatus caused to:
group the at least one network device into one or more network device groups based on the monitoring log; and
determine a transmit power for respective one antenna panel allocated for each of the one or more network device groups.

4. The apparatus of claim 3, wherein the apparatus caused to determine the transmit power for the respective one antenna panel comprises the apparatus cause to:
obtain information associated with positioning service requirement of the apparatus; and
determine the transmit power for the respective one antenna panel based on the information associated with the positioning service requirement.

5. The apparatus of claim 1, wherein the apparatus caused to determine the respective transmit power comprises the apparatus caused to:
in accordance with a determination that a difference between a time point when the positioning is requested and a further time point when a target reference signal of the respective reference signals is received exceeds a threshold difference, set the respective transmit power on the at least two antenna panels to be substantially same without exceeding a transmit power threshold.

6. The apparatus of claim 1, wherein the apparatus is further caused to:
in accordance with a determination that a number of network devices reachable by using an available transmit power is insufficient, increase respective antenna gains on a portion of the at least two antenna panels corresponding to one or more target network devices.

7. The apparatus of claim 1, wherein the apparatus is further caused to:
determine the at least two antenna panels based on at least one of:
respective line of sight status associated with the at least one network device; or
received power levels of the respective reference signals.

8. The apparatus of claim 1, wherein the respective reference signals comprise synchronization signal blocks.

9. The apparatus of claim 1, wherein the at least two antenna panels comprises at least one antenna panel allocated for the at least one network device excluding a network device associated with a serving cell of the apparatus.

10. The apparatus of claim 1, wherein the apparatus is further caused to:
report a capability for performing an uplink transmission for the positioning of the apparatus on multiple panels.

11. The apparatus of claim 1, wherein the message comprises a physical random access channel message.

12. The apparatus of claim 1, wherein the apparatus comprises a terminal device.

13. An apparatus comprising:
at least one processor; and
at least one memory storing instructions that, when executed by the at least one processor, cause the apparatus at least to:
receive, at the apparatus from a terminal device, a message associated with a positioning of the terminal device transmitted by at least two antenna panels of the terminal device with a respective transmit power;
in accordance with a determination that a configuration for the positioning of the terminal device associated with a random access is received from a network management device, perform a positioning measurement associated with the message; and
transmit a result of the positioning measurement to the network management device.

14. The apparatus of claim 13, wherein the apparatus is further caused to:
receive, from the terminal device, a capability for performing an uplink transmission for the positioning of the terminal device on multiple panels.

15. The apparatus of claim 13, wherein the message comprises a physical random access channel message.

16. The apparatus of claim 13, wherein the apparatus comprises a network device, and the network management device comprises a network management function associated with the positioning.

17. An apparatus comprising:
at least one processor; and
at least one memory storing instructions that, when executed by the at least one processor, cause the apparatus at least to:
transmit, from the apparatus to at least one network device, a configuration for a positioning of a terminal device associated with a random access;
receive, from the at least one network device, a result of a positioning measurement associated with a message associated with the positioning of the terminal device; and
determine a position of the terminal device based on the result.

18. The apparatus of claim 17, wherein the apparatus is further caused to:
obtain, a capability for performing an uplink transmission for the positioning of the terminal device on multiple panels.

19. The apparatus of claim 17, wherein the apparatus is further caused to:
determine the configuration for the positioning of the terminal device based on an accuracy requirement of the positioning.

20. The apparatus of claim 17, wherein the apparatus is further caused to:
in accordance with a determination that the positioning of the terminal device is unsatisfied, perform at least one of:
adjusting the configuration for the positioning of the terminal device based on the result; or
transmitting an indication for waking up the terminal device to a radio resource control connected state.

21. The apparatus of claim 17, wherein the message comprises a physical random access channel message.

22. The apparatus of claim 17, wherein the apparatus comprises a network management function associated with the positioning.

23-31. (canceled)

32. A method comprising:
identifying, at a terminal device, at least one network device hearable by the terminal device based on a monitoring of respective reference signals from the at least one network device;
determining respective transmit power on at least two antenna panels allocated for the at least one network device based on a measurement associated with the respective reference signals; and
transmitting, to the at least one network device, a message associated with a positioning of the terminal device by using the at least two antenna panels with the respective transmit power.
